(19) United States
(12) Patent Application Publication
(10) Pub. No.: US 2007/0244685 A1
(43) Pub. Date: Oct. 18, 2007

(54) METHOD FOR MODELING METASTABILITY DECAY USING FENCE LOGIC INSERTION

(75) Inventors: Yee Ja, Round Rock, TX (US); Bradley S. Nelson, Austin, TX (US); Raymond W. Schuppe, South Burlington, VT (US)

Correspondence Address: CANTOR COLBURN LLP - IBM AUSTIN, 55 GRIFFIN ROAD SOUTH, BLOOMFIELD, CT, 06002, US

(73) Assignee: International Business Machines Corporation, Armonk, NY (US)

(21) Appl. No.: 11/279,911

(22) Filed: Apr. 17, 2006

(51) Int. Cl. G06F 17/50

(52) U.S. Cl. 703/15

(57) ABSTRACT

A method for modeling metastablilty decay in digital circuit devices includes identifying each latch at a receiving end of an asynchronous clock boundary, enumerating a latch depth for each latch within logical influence of each of the identified receive latches, and inserting fence logic immediately prior to the input of each latch at an enumerated depth, n, wherein n represents a latch depth at which an indeterminate metastable value received at the asynchronous boundary decays to a random logic value. The fence logic converts an identified indeterminate value to a random logic value, and any indeterminate value initially received is allowed to propagate up to the fence logic.

### BACKGROUND

The present invention relates generally to bistable digital circuits and, more particularly, to a method for modeling metastablilty decay using fence logic insertion.

A bistable digital circuit (such as a flip flop, for example) stores data by using two stable equilibrium states to represent logical 1 and 0. Such devices also have a metastable state in between the two stable states, which is encountered during the transition from one stable state to the other stable state. Although it is theoretically possible for a circuit to stay in this metastable state indefinitely, the duration of the metastable state is short in actual practice. The existence of this metastable equilibrium state means that the conceptually binary flip flop may actually be in a third undefined state for an indefinite amount of time. This ambiguity can lead to random failures in digital systems where only 1s and 0s are expected.

Metastability typically occurs when flip flops have asynchronous inputs and the asynchronous inputs violate the setup and hold conditions of the flip flops. For example, one common type of flip flop is the D flip flop, which has (in one variation thereof) a data input, a clock input and a data output. The data input is sampled and stored in the flip flop on the rising edge of the clock input. The data output changes after a delay to reflect the stored data. However, for the D flip flop to function as described, the data input must be stable for some period of time before the rising clock edge appears, and remain stable for some period of time after the rising clock edge passes.

The period of time before the appearance of the rising clock edge is referred to as the “setup time” while the period of time after the rising clock edge passes is referred to as the “hold time.” Unfortunately, if the data input is not stable during both the setup and hold time (a condition known as a setup and hold violation), the flip flop may go into a metastable state and the data output will not be a 1 or a 0 as desired.

In real physical hardware, a latch that attains a metastable value will assume an indeterminate value (i.e., neither a 0 nor a 1). However, the metastable value will be overwritten or decay to a random (0 or 1) value over time and/or through propagation through additional latches. Thus, synchronization or metastability latches are commonly employed to decay metastable values to a random 0 or 1 value, such that the indeterminate value does not get used by the rest of the logic until the decay has taken place.

It is also possible to design logic without using the requisite number of latches to remove metastability. In such designs (or portions of the design), the cone of logic from this potentially metastable latch will not use the latch value until enough sufficient time has elapsed such that there is a very low probability of metastability. Hence, there are two ways a metastable-generated indeterminate value may be reduced to a random value: 1) by using synchronization latches or 2) by time. In either case, it is possible to model the metastability of a latch having an indeterminate value. However, with existing simulation techniques, an indeterminate value does not decay (as it should) if it is not overwritten.

Accordingly, it is therefore desirable to be able to implement an improved method for modeling metastablilty decay for simulation purposes.

### SUMMARY

The foregoing discussed drawbacks and deficiencies of the prior art are overcome or alleviated by a method for modeling metastablilty decay in digital circuit devices. In an exemplary embodiment, the method includes identifying each latch at a receiving end of an asynchronous clock boundary, enumerating a latch depth for each latch within logical influence of each of the identified receive latches, and inserting fence logic immediately prior to the input of each latch at an enumerated depth, n, wherein n represents a latch depth at which an indeterminate metastable value received at the asynchronous boundary decays to a random logic value. The fence logic converts an identified indeterminate value to a random logic value, and any indeterminate value initially received is allowed to propagate up to the fence logic.

In another embodiment, a machine readable computer program code for modeling metastablilty decay in digital circuit devices includes instructions for causing a computer to implement a method, the method further identifying each latch at a receiving end of an asynchronous clock boundary, enumerating a latch depth for each latch within logical influence of each of the identified receive latches, and inserting fence logic immediately prior to the input of each latch at an enumerated depth, n, wherein n represents a latch depth at which an indeterminate metastable value received at the asynchronous boundary decays to a random logic value. The fence logic converts an identified indeterminate value to a random logic value, and any indeterminate value initially received is allowed to propagate up to the fence logic.

### TECHNICAL EFFECTS

As a result of the above summarized invention, a solution is technically achieved which results in more accurate modeling of metastablilty decay for simulation purposes.

### BRIEF DESCRIPTION OF THE DRAWINGS

Referring to the exemplary drawings wherein like elements are numbered alike in the several Figures:

FIG. 1 is a schematic diagram of an asynchronous boundary between flip flops of different clock domains; and

FIG. 2 is a process flow diagram illustrating a method for modeling metastablilty decay, in accordance with an embodiment of the invention;

FIGS. 3 and 4 illustrate examples of the enumeration of latches within the cone of influence of a receive latch at an asynchronous boundary, in accordance with the methodology of FIG. 2; and

FIG. 5 is a schematic diagram of exemplary fence logic used in conjunction with the methodology of FIG. 2.

### DETAILED DESCRIPTION

Disclosed herein is a method for modeling metastablilty decay in which indeterminate values are “fenced off” such that they do not propagate too far in the logic design, thereby more accurately modeling metastability decay accurately for certain designs while remaining acceptable for others. Briefly stated, fence logic is employed to detect and convert an indeterminate value to a random value by first checking for the presence of an X value and replacing it with a random value.

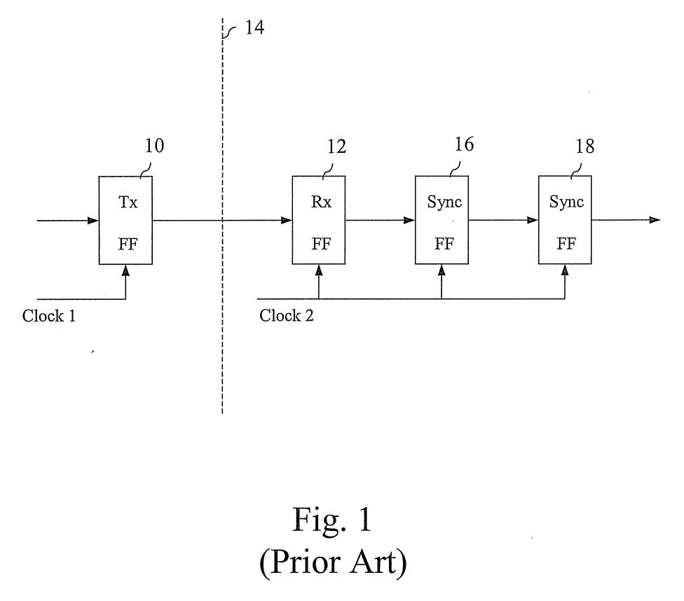

Referring to FIG. 1, there is shown a schematic diagram illustrating an asynchronous boundary between flip flops of different clock domains. A transmitting latch 10 outputs a logical bit value (0 or 1) on the edge of a clock pulse generated by a first clock (clock 1), while a receiving latch 12 samples the data from the transmitting latch 10 on the edge of another clock pulse generated by a second clock (clock 2). Clock 1 and clock 2 are asynchronous with respect to one another. Thus, there is an asynchronous boundary 14 defined between the output of transmitting latch 10 and receiving latch 12. As also shown in FIG. 1, the receiving latch 12 is chained to one or more synchronization latches 16, 18, that are configured to resist a metastable condition.

For purposes of illustration herein, an “X” value is defined to be an indeterminate value (i.e., neither a ‘0’ nor a ‘1’). When using an X value to model metastability or transitioning value in logic simulation, the receive/sink latch of an asynchronous boundary (e.g., receiving latch 12) may take or be driven to an X value temporarily (usually for a single receive domain clock period, such that the initial receive latch will be driven to an X value for only one receive clock period for each metastability causing event). However, in existing simulation techniques, an indeterminate X value does not decay. Rather, the indeterminate value persists until gated off, overwritten, or somehow removed. Where the logic design itself does not get rid of the indeterminate X value, it is necessary to fence off these indeterminate X values such that they do not propagate too far forward.

Assuming “n” represents the number of synchronization/metastability latches in a circuit required to resolve an indeterminate X latch value to a random value, then it should also be true that n latches deep into a receive domain (regardless of the combinational logic which may also exist between the latches or the clocking mechanism of the latches), an indeterminate value originating from the initial receive latch should have already resolved to a random value. This is true because the indeterminate value would either decay before reaching the output of the n^{th} latch, or the latches would all be clocked in a manner which would optimize the forward propagation of the value (i.e., a value is staged from latch to latch until it reaches the output of the n^{th} latch), similar to a value being propagated through synchronization latches.

Therefore, in accordance with an embodiment of the invention, fence logic is inserted at the input(s) of appropriate latches (which reside at a single depth that is greater than or equal to 1, or less than or equal to n) into the design such that an indeterminate value will be converted to a random value. A depth of n is appropriate for logic that is clocked in a manner similar to synchronization latches. A depth value may be specified to be less than the minimum number of synchronization latches required if the indeterminate value persists too long, or reaches logic which it should not before being converted to a random value (i.e., the indeterminate to random value decay occurs in the design because of time and not because the number of latches it goes through). In such cases, the latch with the indeterminate value (and within the latch depth) is not clocked. Thus, using a latch depth equal to the minimum number of synchronization latches required might be overly pessimistic modeling.

The present method of converting an indeterminate value to a random one though fence logic accurately models the behavior of a metastable value decaying through latches, which adequately stage the indeterminate value forward. “Adequately staged” latches mean that once the initial latch captures a new value, each latch (starting with the initial receive latch) is clocked every cycle such that a latch value is pipelined forward through the latches or is overwritten. Hence the indeterminate value must be overwritten and/or be propagated forward to the next latch every cycle until it reaches the fence logic. The forward propagation is similar to the propagation of a value through synchronization latches. The indeterminate value will be interpreted differently by each fan out from the initial receive latch since a different fence point will be used for each fan out which may use the indeterminate value. For a series of latches not properly sequenced, it can still be used if the indeterminate value persisting too long does not matter within the specified latch depth.

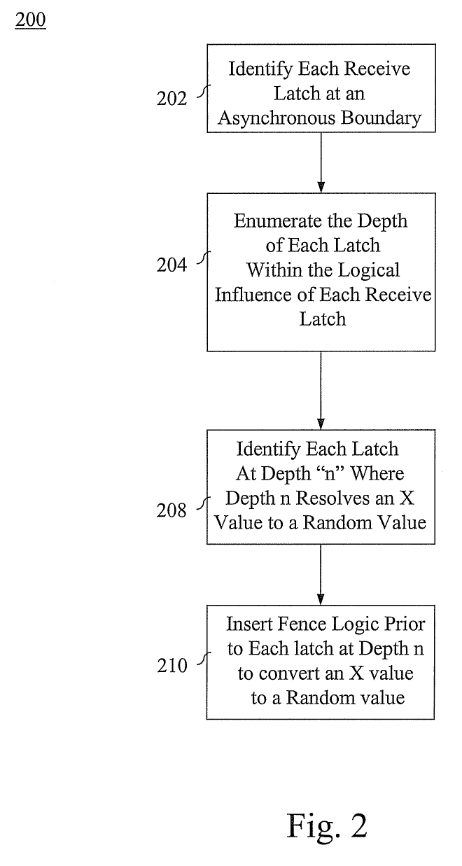

FIG. 2 is a process flow diagram 200 illustrating an exemplary implementation of the above described method, which may be carried out by, for example, various well known simulation programs for digital equipment (e.g., Verilog and VHDL). As shown in block 202, each latch at an asynchronous boundary is identified (e.g., latch 12 in FIG. 1). For each of the receive latches so identified, each of the other latches within the cone of influence (on the downstream side of the receive domain) of the receive latches are also identified. Then, the depth of such latches with respect to the receive latches are enumerated, as shown in block 204.

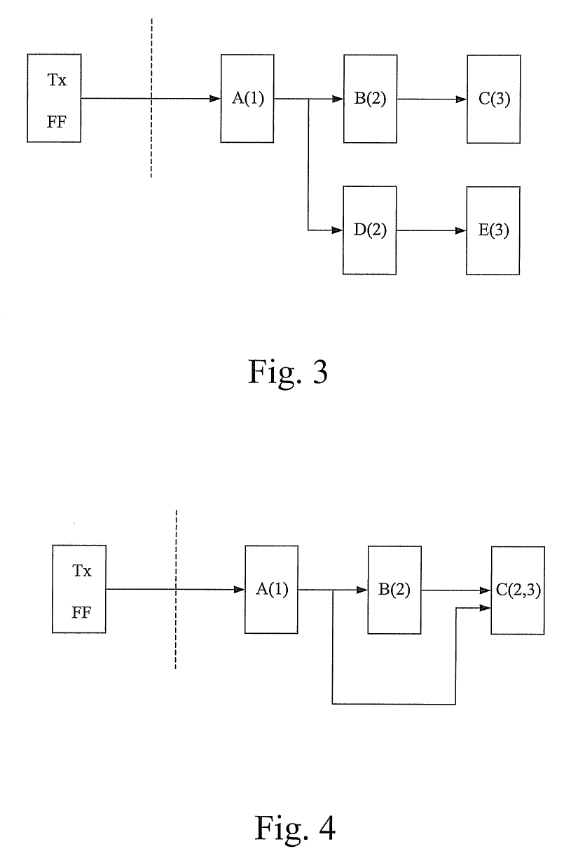

FIG. 3 illustrates one simplified example of the enumeration of the depth of latches in the cone of influence of latch A, which is a receive latch at an asynchronous boundary. The depth of receive latch A is designated as 1 (in parenthesis). As is shown, the output of latch A is coupled to latch B, which therefore has a depth of 2. The output of latch B is in turn coupled to latch C, having a depth of 3. In addition, latch D is also coupled to the output of latch A, and therefore has a depth of 2. Latch E is coupled to the output of latch D and thus has a depth of 3.

FIG. 4 illustrates another example of a latch that is in the cone of influence of more than one latch. As is shown, latch C is coupled to both the outputs of latch A and latch B. As latch B is coupled to the output of latch A, it is therefore seen that latch C has a first enumeration depth of 2 with respect to latch A, and a second enumeration depth of 3, with respect to latch B.

Referring again to FIG. 2, once the latches are enumerated, those latches having a depth “n” are then identified, as shown in block 208. Again, “n” represents the depth of logic at which a metastable value would be resolved to a random value. Then, as shown in block 210, fence logic is inserted prior to the input of each latch at depth n so as to convert a propagated X value to a random (0 or 1) value. By way of example, it will be assumed that for a given set of logic, three latches (L1, L2. L3) are needed to settle a mestable value initially received at L1 to a random value. In this case, the truth table below illustrates the behavior of a 0 to 1 transition at the receive clock cycle:

| Receive Clock Cycle | L1 | L2 | L3 |
|---|---|---|---|
| 0 | 0 | 0 | 0 |
| 1 | *X | 0 | 0 |
| 2 | *1 | *X | 0 |
| 3 | 1 | *1 | *random |
| 4 | 1 | 1 | *1 |

*indicates the cycles where the respective latches need to be clocked

Accordingly, the fence logic is inserted prior to the input at L3 such that the indeterminate X value is detected by the fence logic and converted to a random value for input to L3. In so doing, the modeling allows for initial propagation of the indeterminate value up until such time as it reaches a depth at which it would decay to a random value in actual logic.

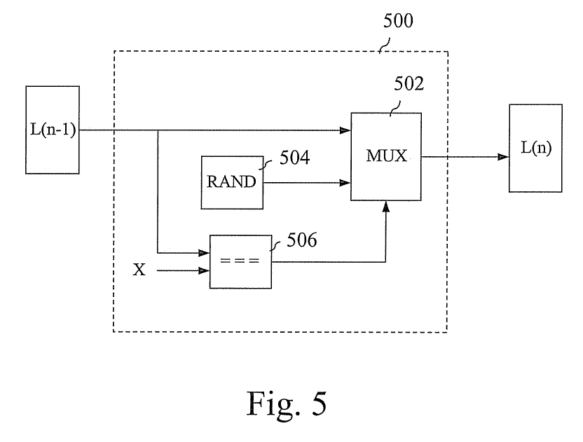

FIG. 5 illustrates a schematic diagram of exemplary fence logic 500 that may be used in conjunction with the modeling methodology described above. As is shown, the fence logic 500 is inserted prior to the input of a latch at depth n (winch is the depth needed to convert indeterminate values to random values). A multiplexer 502 selectively controls the input to latch L(n), which will be either the output of latch L(n−1) or a random logic value generated by random number generator 504. An X-comparator 506 (the “===” operator representing an equivalent function as a the Verilog case equality operator) is used to determine whether the output of latch L(n−1) is of an indeterminate X value. If so, then the multiplexer 502 outputs the randomly generated value to the input of latch L(n). If not, then the output of latch L(n−1) is passed through to the input of Latch L(n).

In this manner, a metastable value may be propagated from a receiving latch at an asynchronous boundary, but converted to the decayed random value just prior to the latches at depth n. Thereby, metastability decay is more effectively modeled in a simulation environment. Otherwise, simply converting a received indeterminate value to a random value at the receive latch would not account for the possibility that the indeterminate value may be viewed differently by downstream logic. On the other hand, without the fence logic, an indeterminate value that is not converted to a random value at the appropriate locations will continue to propagate downstream further than would be the case in the actual hardware. Finally, it should also be appreciated that although the above described examples depict direct latch-to-latch connections, other types of combinational logic could also be present between the latches prior to the location of the inserted fence logic.

In view of the above, the present method embodiments may therefore take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to implement the exemplary method described above and illustrated in FIG. 2.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for modeling metastablilty decay in digital circuit devices, the method comprising:
identifying each latch at a receiving end of an asynchronous clock boundary;
enumerating a latch depth for each latch within logical influence of each of said identified receive latches; and
inserting fence logic immediately prior to the input of each latch at an enumerated depth, n, wherein n represents a latch depth at which an indeterminate metastable value received at said asynchronous boundary decays to a random logic value, wherein said fence logic converts an identified indeterminate value to a random logic value; and
wherein any indeterminate value initially received is allowed to propagate up to said fence logic.

2. The method of claim 1, wherein said fence logic is configured to determine whether an output of a latch at a depth of n−1 is of indeterminate value.

3. The method of claim 2, wherein said fence logic includes an indeterminate value comparator.

4. The method of claim 3, wherein said indeterminate value comparator controls the output of a multiplexer within said fence logic.

5. The method of claim 4, wherein said fence logic further comprises a random number generator coupled to one input of said multiplexer and said output of said latch at depth n−1.

6. A storage medium, comprising:
a machine readable computer program code for modeling metastablilty decay in digital circuit devices; and
instructions for causing a computer to implement a method, the method further comprising:
identifying each latch at a receiving end of an asynchronous clock boundary;
enumerating a latch depth for each latch within logical influence of each of said identified receive latches; and
inserting fence logic immediately prior to the input of each latch at an enumerated depth, n, wherein n represents a latch depth at which an indeterminate metastable value received at said asynchronous boundary decays to a random logic value, wherein said fence logic converts an identified indeterminate value to a random logic value; and
wherein any indeterminate value initially received is allowed to propagate up to said fence logic.

7. The storage medium of claim 6, wherein said fence logic is configured to determine whether an output of a latch at a depth of n−1 is of indeterminate value.

8. The storage medium of claim 7, wherein said fence logic includes an indeterminate value comparator.

9. The storage medium of claim 8, wherein said indeterminate value comparator controls the output of a multiplexer within said fence logic.

10. The method of claim 9, wherein said fence logic further comprises a random number generator coupled to one input of said multiplexer and said output of said latch at depth n−1.
